(19) United States
(12) Patent Application Publication
(10) Pub. No.: US 2024/0144165 A1
(43) Pub. Date: May 2, 2024

(54) GRAPH NODE RELATIONSHIP REPRESENTATION GENERATION AND GRAPH NODE SERVICE RELATIONSHIP PREDICTION

(71) Applicant: Alipay (Hangzhou) Information Technology Co., Ltd., Hangzhou (CN)

(72) Inventors: Shuo Yang, Hangzhou (CN); Zhiqiang Zhang, Hangzhou (CN); Jun Zhou, Hangzhou (CN)

(73) Assignee: Alipay (Hangzhou) Information Technology Co., Ltd., Hangzhou (CN)

(21) Appl. No.: 18/398,447

(22) Filed: Dec. 28, 2023

Related U.S. Application Data
(63) Continuation of application No. PCT/CN2022/104328, filed on Jul. 7, 2022.

(30) Foreign Application Priority Data
Aug. 30, 2021 (CN) 202111003074.7

(51) Int. Cl. G06Q 10/0835; G06Q 10/067

(52) U.S. Cl. CPC G06Q 10/0835; G06Q 10/067

(57) ABSTRACT

Embodiments of this specification provide methods and apparatuses for generating a graph node relationship representation and methods and apparatuses for predicting a graph node service relationship. In an implementation, a method includes: determining node representations of a first graph node and a second graph node based on performing node representation propagation and node representation aggregation starting from the first graph node and the second graph node, and generating a node relationship representation between the first graph node and the second graph node based on the node representations.

### CROSS-REFERENCE TO RELATED APPLICATIONS

This application is a continuation of PCT Application No. PCT/CN2022/104328, filed on Jul. 7, 2022, which claims priority to Chinese Patent Application No. 202111003074.7, filed on Aug. 30, 2021, and each application is hereby incorporated by reference in its entirety.

### TECHNICAL FIELD

Embodiments of this specification generally relate to the field of graph data processing, and in particular, to graph node relationship representation generation methods and apparatuses for generating a node relationship representation between graph nodes in graph data and graph node service relationship prediction methods and apparatuses for predicting a service relationship between graph nodes in graph data.

### BACKGROUND

In some service scenarios, service data are usually processed into graph data. In the graph data, for example, service entities of users, enterprises, and merchants are represented as nodes in the graph data, and relationships between the service entities are represented as edge attribute relationships between the nodes. During service processing, it is needed to predict whether a service relationship exists between two given nodes (service entities) in the graph data. Then, subsequent service decision-making and processing are performed based on a service relationship prediction result. For example, in a product recommendation scenario, graph data can be generated based on historical product purchase data of a user, so that the graph data can be used to predict whether a product purchase relationship exists between the user and a certain product, to be specific, whether the user will purchase the product, and it is determined, based on a product purchase relationship prediction result, whether to recommend the product to the user. In a social scenario, graph data can be generated based on social data, so that the graph data can be used to predict whether two users are in a friend relationship, and subsequent social processing is performed based on a friend relationship prediction result. In a supply chain mining scenario, graph data can be generated based on historical enterprise supply relationship data, so that the graph data can be used to predict whether two enterprises constitute a supply chain upstream-downstream relationship, and supply chain mining is performed based on a supply chain upstream-downstream relationship prediction result.

### SUMMARY

In view of the description above, embodiments of this specification provide methods for generating a graph node relationship representation and methods and apparatuses for predicting a graph node service relationship. With the methods for generating a graph node relationship representation and the methods and apparatuses for predicting a graph node service relationship, an obtained graph node relationship representation between graph nodes can accurately reflect node attribute information of the graph nodes and interaction structure information between the graph nodes, thereby improving accuracy of predicting a service relationship between the graph nodes.

According to an aspect of some embodiments of this specification, a method for generating a node relationship representation between a first graph node and a second graph node in graph data is provided, where the graph data are generated based on service data. The method includes the following: separately performing node representation propagation and node representation aggregation starting from the first graph node and the second graph node to determine node representations of the second graph node and the first graph node; and generating a node relationship representation between the first graph node and the second graph node based on the node representations of the first graph node and the second graph node; where specified quantities of iteration processes are performed for the node representation propagation and the node representation aggregation; during the node representation propagation: a node propagation representation of the previous iteration process of each source graph node in a source graph node set of a current iteration process is propagated to each target graph node in a target graph node set of the source graph node, where the target graph node set includes neighboring graph nodes of the source graph node; and node propagation representations of the current iteration process of the target graph nodes are generated based on node propagation representations received by the target graph nodes and node propagation representations of the target graph nodes of the previous iteration process; and during the node representation aggregation: a node representation of a current iteration process of an aggregation graph node is generated based on a node representation of the previous iteration process of the aggregation graph node and a node representation of the previous iteration process of a neighboring graph node of the aggregation graph node, where the aggregation graph node includes the first graph node or the second graph node, and an initial node representation of a graph node is generated based on a node propagation representation of the graph node and an original feature of the graph node.

Optionally, in an example of the above-mentioned aspect, the generating a node relationship representation between the first graph node and the second graph node based on the node representations of the first graph node and the second graph node can include the following: splicing the node representations of the first graph node and the second graph node to generate the node relationship representation between the first graph node and the second graph node.

Optionally, in an example of the above-mentioned aspect, that node propagation representations of the current iteration process of the target graph nodes are generated based on node propagation representations received by the target graph nodes and node propagation representations of the target graph nodes of the previous iteration process can include the following: generating the node propagation representations of the current iteration process of the target graph nodes based on node propagation representations received by the target graph nodes from neighboring graph nodes, edge relationship features between the target graph nodes and the neighboring graph nodes, and the node propagation representations of the target graph nodes of the previous iteration process.

Optionally, in an example of the above-mentioned aspect, that an initial node representation of a graph node is generated based on a node propagation representation of the graph node and an original feature of the graph node can include the following: generating the initial node representation of the graph node by splicing the node propagation representation of the graph node and the original feature of the graph node.

Optionally, in an example of the above-mentioned aspect, the method is implemented based on a graph neural network.

Optionally, in an example of the above-mentioned aspect, that a node representation of a current iteration process of an aggregation graph node is generated based on a node representation of the previous iteration process of the aggregation graph node and a node representation of the previous iteration process of a neighboring graph node of the aggregation graph node can include the following: generating the node representation of the current iteration process of the aggregation graph node by aggregating the node representation of the previous iteration process of the aggregation graph node and the node representation of the previous iteration process of the neighboring graph node of the aggregation graph node by using an aggregation function.

Optionally, in an example of the above-mentioned aspect, the graph neural network includes a graph neural network having an Attention mechanism and an LSTM aggregator.

Optionally, in an example of the above-mentioned aspect, that node propagation representations of the current iteration process of the target graph nodes are generated based on node propagation representations received by the target graph nodes and node propagation representations of the target graph nodes of the previous iteration process can include the following: aggregating, by using an Attention operation, the node propagation representations received by the target graph nodes to obtain neighboring-node propagation representations of the target graph nodes; and performing, by using the LSTM aggregator, LSTM aggregation on the neighboring-node propagation representations of the target graph nodes and the node propagation representations of the previous iteration process of the target graph nodes to generate the node propagation representations of the current iteration process of the target graph nodes.

Optionally, in an example of the above-mentioned aspect, the service data include one of the following service data: social data; financial transaction data; product transaction data; and enterprise supply relationship data.

According to another aspect of some embodiments of this specification, a method for predicting a service relationship between a first graph node and a second graph node in graph data is provided, where the graph data are generated based on service data. The method includes the following: separately performing node representation propagation and node representation aggregation starting from the first graph node and the second graph node to determine node representations of the second graph node and the first graph node; generating a node relationship representation between the first graph node and the second graph node based on the node representations of the first graph node and the second graph node; and predicting the service relationship between the first graph node and the second graph node based on the node relationship representation between the first graph node and the second graph node; where specified quantities of iteration processes are performed for the node representation propagation and the node representation aggregation; during the node representation propagation: a node propagation representation of the previous iteration process of each source graph node in a source graph node set of a current iteration process is propagated to each target graph node in a target graph node set of the source graph node, where the target graph node set includes neighboring graph nodes of the source graph node; and node propagation representations of the current iteration process of the target graph nodes are generated based on node propagation representations received by the target graph nodes and node propagation representations of the target graph nodes of the previous iteration process; and during the node representation aggregation: a node representation of a current iteration process of an aggregation graph node is generated based on a node representation of the previous iteration process of the aggregation graph node and a node representation of the previous iteration process of a neighboring graph node of the aggregation graph node, where the aggregation graph node includes the first graph node or the second graph node, and an initial node representation of a graph node is generated based on a node propagation representation of the graph node and an original feature of the graph node.

According to another aspect of some embodiments of this specification, an apparatus for generating a node relationship representation between a first graph node and a second graph node in graph data is provided, where the graph data are generated based on service data. The apparatus includes the following: a node representation determining unit, configured to separately perform node representation propagation and node representation aggregation starting from the first graph node and the second graph node to determine node representations of the second graph node and the first graph node; and a node relationship representation generation unit, configured to generate a node relationship representation between the first graph node and the second graph node based on the node representations of the first graph node and the second graph node; where the node representation determining unit includes the following: a node representation propagation module, configured to propagate a node propagation representation of the previous iteration process of each source graph node in a source graph node set of a current iteration process to each target graph node in a target graph node set of the source graph node, where the target graph node set includes neighboring graph nodes of the source graph node; and generate node propagation representations of the current iteration process of the target graph nodes based on node propagation representations received by the target graph nodes and node propagation representations of the target graph nodes of the previous iteration process; and a node representation aggregation module, configured to generate a node representation of a current iteration process of an aggregation graph node based on a node representation of the previous iteration process of the aggregation graph node and a node representation of the previous iteration process of a neighboring graph node of the aggregation graph node, where the aggregation graph node includes the first graph node or the second graph node, and an initial node representation of a graph node is generated based on a node propagation representation of the graph node and an original feature of the graph node, where the node representation propagation module and the node representation aggregation module perform specified quantities of iteration processes.

Optionally, in an example of the above-mentioned aspect, the node relationship representation generation unit splices the node representations of the first graph node and the second graph node to generate the node relationship representation between the first graph node and the second graph node.

Optionally, in an example of the above-mentioned aspect, the node representation propagation module generates the node propagation representations of the current iteration process of the target graph nodes based on node propagation representations received by the target graph nodes from neighboring graph nodes, edge relationship features between the target graph nodes and the neighboring graph nodes, and the node propagation representations of the target graph nodes of the previous iteration process.

Optionally, in an example of the above-mentioned aspect, the node representation aggregation module generates the initial node representation of the graph node by splicing the node propagation representation of the graph node and the original feature of the graph node.

Optionally, in an example of the above-mentioned aspect, the apparatus is implemented based on a graph neural network, and the node representation aggregation module generates the node representation of the current iteration process of the aggregation graph node by aggregating the node representation of the previous iteration process of the aggregation graph node and the node representation of the previous iteration process of the neighboring graph node of the aggregation graph node by using an aggregation function.

According to another aspect of some embodiments of this specification, an apparatus for predicting a service relationship between a first graph node and a second graph node in graph data is provided, where the graph data are generated based on service data. The apparatus includes the following: a node representation determining unit, configured to separately perform node representation propagation and node representation aggregation starting from the first graph node and the second graph node to determine node representations of the second graph node and the first graph node; a node relationship representation generation unit, configured to generate a node relationship representation between the first graph node and the second graph node based on the node representations of the first graph node and the second graph node; and an inter-node service relationship prediction unit, configured to predict the service relationship between the first graph node and the second graph node based on the node relationship representation between the first graph node and the second graph node; where the node representation determining unit includes the following: a node representation propagation module, configured to propagate a node propagation representation of the previous iteration process of each source graph node in a source graph node set of a current iteration process to each target graph node in a target graph node set of the source graph node, where the target graph node set includes neighboring graph nodes of the source graph node; and generate node propagation representations of the current iteration process of the target graph nodes based on node propagation representations received by the target graph nodes and node propagation representations of the target graph nodes of the previous iteration process; and a node representation aggregation module, configured to generate a node representation of a current iteration process of an aggregation graph node based on a node representation of the previous iteration process of the aggregation graph node and a node representation of the previous iteration process of a neighboring graph node of the aggregation graph node, where the aggregation graph node includes the first graph node or the second graph node, and an initial node representation of a graph node is generated based on a node propagation representation of the graph node and an original feature of the graph node, where the node representation propagation module and the node representation aggregation module perform specified quantities of iteration processes.

According to some embodiments of this specification, an apparatus for generating a node relationship representation between a first graph node and a second graph node in graph data is provided, where the graph data are generated based on service data, and the apparatus includes the following: at least one processor; a storage coupled to the at least one processor; and a computer program stored in the storage, where the at least one processor executes the computer program to implement the above-mentioned methods for generating a graph node relationship representation.

According to some embodiments of this specification, a computer-readable storage medium is provided, where the computer-readable storage medium stores an executable instruction, and when the instruction is executed, a processor is enabled to perform the above-mentioned methods for generating a graph node relationship representation.

According to some embodiments of this specification, a computer program product is provided, including a computer program, where the computer program is executed by a processor to implement the above-mentioned methods for generating a graph node relationship representation.

According to some embodiments of this specification, an apparatus for predicting a relationship between a first graph node and a second graph node in graph data is provided, where the graph data are generated based on service data. The apparatus includes the following: at least one processor; a storage coupled to the at least one processor; and a computer program stored in the storage, where the at least one processor executes the computer program to implement the methods for predicting a service relationship between graph nodes.

According to some embodiments of this specification, a computer-readable storage medium is provided, where the computer-readable storage medium stores an executable instruction, and when the instruction is executed, a processor is enabled to perform the methods for predicting a service relationship between graph nodes.

According to some embodiments of this specification, a computer program product is provided, including a computer program, where the computer program is executed by a processor to implement the methods for predicting a service relationship between graph nodes.

### BRIEF DESCRIPTION OF DRAWINGS

The essence and advantages of this specification can be further understood with reference to the following accompanying drawings. In the accompanying drawings, similar components or features can have the same reference numerals.

FIG. 1 is a schematic diagram illustrating an example structure of graph data, according to some embodiments of this specification;

FIG. 2 is an example flowchart illustrating a graph node relationship representation generation method for generating a node relationship representation between a first graph node and a second graph node in graph data, according to some embodiments of this specification;

FIG. 3 is an example schematic diagram illustrating a node propagation process of graph data, according to some embodiments of this specification;

FIG. 4 is an example flowchart illustrating a node representation propagation processing process, according to some embodiments of this specification;

FIG. 5 is an example schematic diagram illustrating a node propagation representation generation process based on a graph neural network, according to some embodiments of this specification;

FIG. 6 is an example schematic diagram illustrating node representation propagation processing, according to some embodiments of this specification;

FIG. 7 is an example schematic diagram illustrating node representation aggregation processing, according to some embodiments of this specification;

FIG. 8 is an example flowchart illustrating a graph node service relationship prediction method for predicting a service relationship between a first graph node and a second graph node in graph data, according to some embodiments of this specification;

FIG. 9 is an example schematic diagram illustrating an inter-graph node service relationship prediction process, according to some embodiments of this specification;

FIG. 10 is an example block diagram illustrating a graph node relationship representation generation apparatus for generating a node relationship representation between a first graph node and a second graph node in graph data, according to some embodiments of this specification;

FIG. 11 is an example flowchart illustrating a graph node service relationship prediction apparatus for predicting a service relationship between a first graph node and a second graph node in graph data, according to some embodiments of this specification;

FIG. 12 is an example schematic diagram illustrating a graph node relationship representation generation apparatus that is implemented based on a computer system and that is used to generate a node relationship representation between a first graph node and a second graph node in graph data, according to some embodiments of this specification; and

FIG. 13 is an example schematic diagram illustrating a graph node service relationship prediction apparatus that is implemented based on a computer system and that is used to predict a service relationship between a first graph node and a second graph node in graph data, according to some embodiments of this specification.

### DESCRIPTION OF EMBODIMENTS

The subject matters described in this specification are discussed below with reference to some example implementations. It should be understood that the discussion of these implementations is merely intended to enable a person skilled in the art to better understand the subject matters described in this specification, and is not intended to limit the protection scope, applicability, or examples described in the claims. The functions and arrangements of the elements under discussion can be changed without departing from the protection scope of this specification. Various processes or components can be omitted, replaced, or added in various examples as needed. For example, the described method can be performed in a sequence different from the described sequence, and the steps can be added, omitted, or combined. In addition, the features described in some examples can also be combined in other examples.

As used in this specification, the term “include” and variants thereof represent an open term, which means “including but not limited to”. The term “based on” represents “at least partially based on”. The term “some embodiments” represents “at least one embodiment”. The term “some other embodiments” represents “at least one other embodiment”. The terms “first”, “second”, etc. can refer to different or identical objects. Other definitions, whether explicit or implicit, can be included below. Unless expressly specified in the context, the definition of a term is consistent throughout the specification.

When service data are processed into graph data, during service processing, it is needed to predict a service relationship between two given graph nodes in graph data. Service relationship prediction solutions can include, for example, a service relationship prediction solution based on a graph structure, a service relationship prediction solution based on a node-level graph neural network, and a service relationship prediction solution based on an edge-level graph neural network.

In the service relationship prediction solution based on a graph structure, features of two graph nodes that need prediction are directly computed, for example, a quantity of common neighbors and a Katz Index, so as to measure a similarity between the two graph nodes, and determine, based on the similarity, whether a service relationship exists between the two graph nodes. In the service relationship prediction solution, a certain prior hypothesis needs to exist, that is, it is considered that a service relationship exists between two graph nodes that meet a specific condition. However, such a service relationship prediction solution cannot be adaptively adjusted based on different prediction tasks, and cannot be incorporated into graph node attributes during node representation.

In the service relationship prediction solution based on a node-level graph neural network, a graph neural network model is used to separately perform graph node representation on two graph nodes that need prediction, and then link binary classification prediction is performed based on graph node representations of the two graph nodes. However, in this service relationship prediction solution, graph node representation learning is separately performed on two graph nodes. Only respective neighbor distribution information of the two graph nodes can be modeled, and an interaction structure (for example, a path) between the two graph nodes and interaction structure attributes cannot be directly modeled.

In the service relationship prediction solution based on an edge-level graph neural network, first, structural features are extracted for one edge or all domain graph nodes associated with one edge in graph data. For example, connectivity features of one edge are extracted by using a random walk, and node representations are used to represent locations in one edge for domain graph nodes associated with this edge, and so on. Next, a node-level graph neural network is used to aggregate graph node domain attribute information to obtain a final representation of the edge. Then, whether a service relationship exists between two graph nodes connected to the edge is predicted based on the final representation of the edge. However, such a service relationship prediction solution cannot incorporate graph node attribute information when extracting structural features of two graph nodes, and there is also a prior hypothesis in structural feature selection.

In view of the description above, some embodiments of this specification provide solutions for predicting a service relationship between graph nodes. In the graph node service relationship prediction solutions, when graph node relationship representation is performed, node representation propagation and node representation aggregation are separately performed starting from one graph node to determine a node representation of a correspondent graph node. Specified quantities of iteration processes are performed for the node representation propagation and the node representation aggregation. By performing the node representation propagation and the node representation aggregation in the iteration processes, graph node attribute information and interaction structure information of each graph node can be incorporated into a node representation of a correspondent graph node. After node representations of two graph nodes are obtained as described above, a graph node relationship representation between the two graph nodes is generated based on the node representations of the two graph nodes, and inter-node service relationship prediction is performed based on the node relationship representation between the two graph nodes. By using the inter-node service relationship prediction, as the graph node attribute information and interaction structure information of the two graph nodes are incorporated into the node representations of the graph nodes, the obtained graph node relationship representation between the graph nodes can accurately reflect node attribute information of the graph nodes and interaction structure information between the graph nodes, thereby improving accuracy of predicting a service relationship between the graph nodes.

With reference to the accompanying drawings, the following describes graph node relationship representation generation methods and apparatuses for generating a node relationship representation between a first graph node and a second graph node in graph data as well as graph node service relationship prediction methods and apparatuses for predicting a service relationship between a first graph node and a second graph node in graph data, according to some embodiments of this specification.

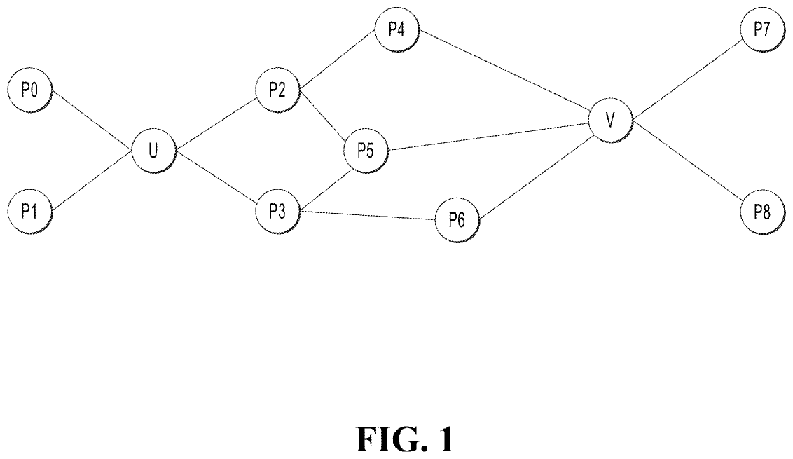

FIG. 1 is an example schematic diagram illustrating a graph data structure, according to some embodiments of this specification.

The graph data structure shown in FIG. 1 includes 11 graph nodes, that is, graph nodes u, v, and P0 to P8, and neighboring relationships shown in FIG. 1 exist between the 11 graph nodes. In this specification, the term “neighboring relationship” refers to that an edge connection exists between two graph nodes. For example, graph nodes P0, P1, P2 and P3 are 1-step neighboring graph nodes of graph node u, and graph node P4 is a 2-step neighboring graph node of graph node u. In addition, in this specification, a neighboring graph node represents a 1-step neighboring graph node, unless otherwise specified.

In this specification, graph data can be generated based on various service data. Each graph node in the generated graph data has node attribute information. In addition, optionally, an edge between two graph nodes can further have edge attribute information (an edge feature). Node attribute information and edge attribute information are related to a service scenario of service data. Examples of service data can include, but are not limited to, social data, financial transaction data, product transaction data, and enterprise supply relationship data.

The social data include service data obtained in a social network scenario. In graph data generated based on the social data, graph nodes include social users (social accounts), for example, “Zhang San” and “Li Si”, and node attribute information of the graph nodes can include, for example, age, education level, address, occupation, etc. For example, edges between graph nodes can include relationships between users, for example, classmates/colleagues. A predicted service relationship can include, for example, whether a friend relationship exists between social users.

The financial transaction data include financial transaction data obtained in a financial transaction scenario. In graph data generated based on the financial transaction data, graph nodes include financial entities, and node attribute information of the graph nodes can include, for example, financial entity registration information, legal person information, and account information. For example, edges between graph nodes can include transfer relationships between financial entities. A predicted service relationship can include, for example, whether an associated entity relationship exists between financial entities.

The product transaction data include product transaction data obtained in a product transaction scenario. In graph data generated based on the product transaction data, graph nodes can include a user, a product, and a merchant, and node attribute information of the graph nodes can include, for example, user age, user education level, user address, user occupation, product origin, product material, product model, merchant name, and merchant registration place, etc. For example, edges between the graph nodes can include a product purchase relationship between a user and a product, and an ownership relationship between a product and a merchant. A predicted service relationship can include, for example, whether a user has a product purchase intention.

The enterprise supply relationship data include enterprise supply relationship data obtained in an enterprise supply scenario. In graph data generated based on the enterprise supply relationship data, graph nodes can include enterprises, and node attributes of the graph nodes can include, for example, an enterprise name, an enterprise registration place, and a product generated by an enterprise, etc. For example, edges between the graph nodes can include a product supply behavior occurring between enterprises. A predicted service relationship can include, for example, whether a supply chain upstream-downstream relationship exists between two enterprises.

It is worthwhile to note that in this specification, a graph data structure may also be referred to as a graph network. In addition, examples of the graph network can include, for example, a directed graph network, an undirected graph network, etc.

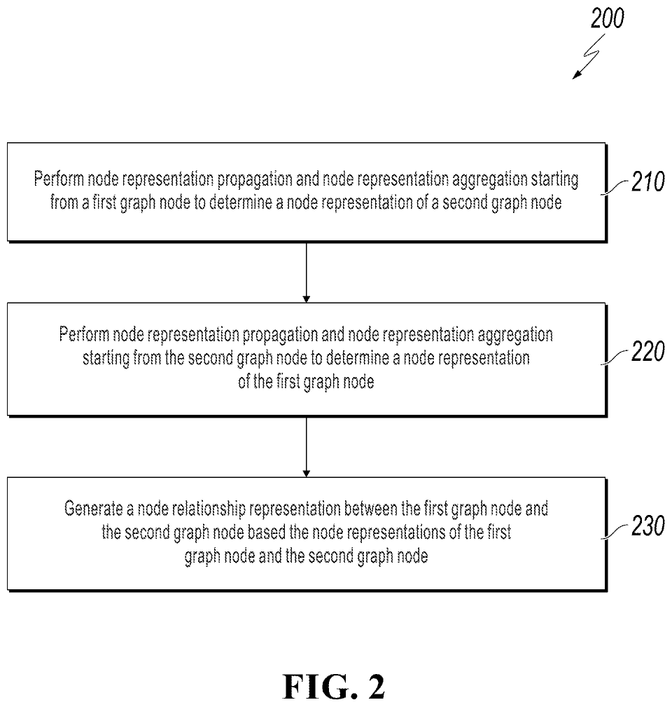

FIG. 2 is an example flowchart illustrating a graph node relationship representation generation method 200 for generating a node relationship representation between a first graph node and a second graph node in graph data, according to some embodiments of this specification. It is worthwhile to note that the first graph node and the second graph node can be any graph nodes in the graph data.

As shown in FIG. 2, at 210, node representation propagation and node representation aggregation are performed starting from the first graph node to determine a node representation of the second graph node. Here, specified quantities of iteration processes are performed for the node representation propagation and the node representation aggregation. In an example, the graph node relationship representation generation method can be implemented based on a graph neural network. In this case, quantities of iterations in the iteration processes performed for the node representation propagation and the node representation aggregation can be a model depth of the graph neural network. The term “model depth” refers to a hop count of graph nodes that each graph node can affect, to be specific, a hop count of graph nodes that node attribute information of each graph node can be propagated to. In an example, assuming that a model depth of the graph neural network is 2, a hop count of graph nodes that each graph node can affect is 2. In this case, for the graph network shown in FIG. 1, the first graph node is graph node u, and the second graph node is graph node v. Node attribute information of graph node u can be propagated to graph nodes including P0, P1, P2, P3, P4, P5, and P6. Graph nodes P0, P1, P2, and P3 are one-hop target graph nodes (1-step neighboring graph nodes) of graph node u, and graph nodes P4, P5, and P6 are two-hop target graph nodes (2-step neighboring graph nodes) of graph node u. In addition, the node attribute information of graph node u cannot be propagated to graph nodes beyond 2 hops, for example, graph nodes v, P7, and P8. In this specification, examples of the graph neural network can include, but are not limited to, a graph convolutional network (GCN), a graph attention network (GAT), etc.

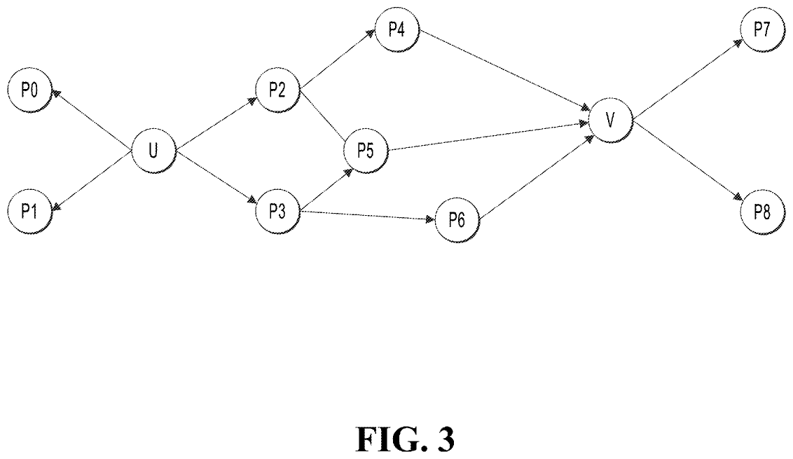

FIG. 3 is an example schematic diagram illustrating a node propagation process of graph data, according to some embodiments of this specification.

As shown in FIG. 3, in the first iteration process of node representation propagation starting from graph node u, a source graph node is graph node u, and target graph nodes are graph nodes P0, P1, P2, and P3. During the first iteration process, a node propagation feature of graph node u is separately propagated to graph nodes P0, P1, P2 and P3. In the second iteration process, source graph nodes are graph nodes P0, P1, P2, and P3, and target graph nodes are graph nodes P4, P5, and P6. In the second iteration process, a node propagation feature of source graph node P2 is separately propagated to graph nodes P4 and P5, and a node propagation feature of source graph node P3 is separately propagated to graph nodes P5 and P6.

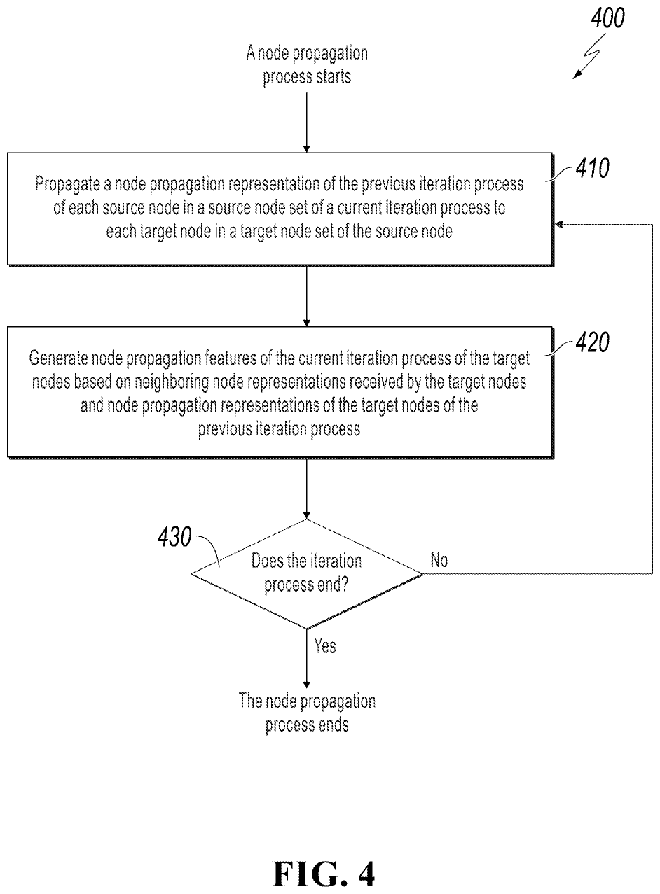

FIG. 4 is an example flowchart illustrating a node representation propagation process 400, according to some embodiments of this specification.

As shown in FIG. 4, at 410, a node propagation representation of the previous iteration process of each source graph node in a source graph node set of a current iteration process is propagated to each target graph node in a target graph node set of the source graph node, where the target graph node set includes 1-step neighboring graph nodes of the source graph node.

At 420, the node propagation representations of the current iteration process of the target graph nodes are generated based on node propagation representations received by the target graph nodes from neighboring graph nodes and node propagation representations of the target graph nodes of the previous iteration process.

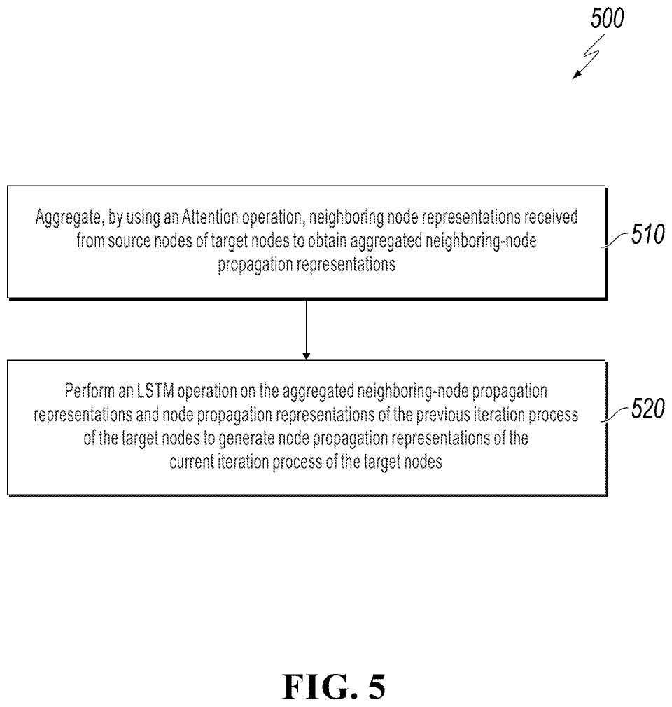

FIG. 5 is an example schematic diagram illustrating a node propagation representation generation process 500 based on a graph neural network, according to some embodiments of this specification. In the example of FIG. 5, the graph neural network includes a graph neural network having an Attention mechanism and an LSTM aggregator.

As shown in FIG. 5, at 510, node propagation representations received from neighboring graph nodes by target graph nodes are aggregated by using an Attention operation (ATT_OP) to obtain neighboring-node propagation representations of the target graph nodes.

In an example, ATT_OP processing can be represented by using the following expression:

$${α}_{q , p}^{k} = \frac{exp ( {v}_{∅}^{{k}^{T}} σ ( {W}_{∅ 1}^{k} [ {X}_{p} , {h}_{u , q}^{k - 1} ] ) )}{{\sum }_{{q}^{′} ∈ {N}_{s}^{k} , ( {q}^{′} , p ) ∈ {ε}_{u}^{H}} exp ( {v}_{∅}^{{k}^{T}} σ ( {W}_{∅ 1}^{k} [ {X}_{p} , {h}_{u , {q}^{′}}^{k - 1} ] )}$$

$${Z}_{u , p}^{k} = σ ( {W}_{∅ 2}^{k} [ {\sum }_{{q}^{′} ∈ {N}_{s}^{k} , ( {q}^{′} , p ) ∈ {ε}_{u}^{H}} {α}_{q , p}^{k} {h}_{u , q}^{k - 1} , {X}_{p} ]$$

v_{∅}^{k} is a given parameter in a graph neural network model, W_{∅1}^{k} and W_{∅2}^{k} are weight coefficient matrices in the graph neural network model, α_{q,p}^{k} is an attention value propagated from source graph node q to target graph node p, h_{u,q}^{k-1} is a node propagation representation of source graph node q at the (k−1)th iteration, Xₚ is an original feature of target graph node p, and Z_{u,p}^{k} indicates a neighboring-node propagation representation of target graph node p that is obtained after k iterations and that is propagated starting from graph node u.

In addition, in an example, when an edge relationship feature e_{q,p} is further included between the two graph nodes q and p, a computing equation of Z_{u,p}^{k} can be modified as follows:

Z_{u,p}^{k}=σ(W_{∅2}^{k}[Σ_{q′∈N}_{ₛ}_{^{k}}_{, (q′,p)∈ε}_{ᵤ}_{^{H}}α_{q,p}^{k}h_{u,q}^{k-1},Xₚ,e_{q,p}]

At 520, the LSTM aggregator is used to perform LSTM aggregation (LSTM_OP) on the neighboring-node propagation representations of the target graph nodes and the node propagation representations of the previous iteration process of the target graph nodes to generate the node propagation representations of the current iteration process of the target graph nodes.

In an example, LSTM_OP processing can be represented by using the following expressions:

i_{u,p}^{k}=σ(W_{φi}[h_{u,p}^{k-1},Z_{u,p}^{k}])

f_{u,p}^{k}=σ(W_{φf}[h_{u,p}^{k-1},Z_{u,p}^{k}])

c_{u,p}^{k}=f_{u,p}^{k-1}⊙c_{u,p}^{k-1}+i_{u,p}^{k}⊙tanh(W_{φc}[h_{u,p}^{k-1},Z_{u,p}^{k}])

o_{u,p}^{k}=σ(W_{φo}[h_{u,p}^{k-1},Z_{u,p}^{k}])

h_{u,p}^{k}=o_{u,p}^{k}⊙tanh(c_{u,p}^{k})

i_{u,p}^{k} is an input gate, f_{u,p}^{k} is a forget gate, o_{u,p}^{k} is an output gate, c_{u,p}^{k} is a cell state, and h_{u,p}^{k-1} and h_{u,p}^{k} are node propagation representations of target graph node p that are obtained after the (k−1)th and kth iterations and that are propagated starting from graph node u.

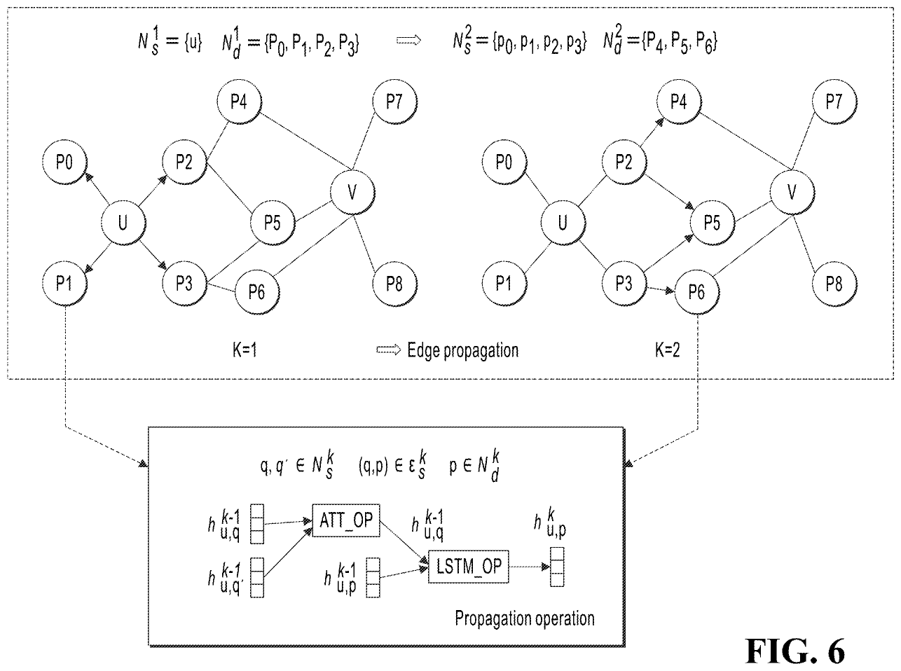

The following uses the graph network example shown in FIG. 1 as an example to describe node representation propagation processing. FIG. 6 is an example schematic diagram illustrating node representation propagation processing, according to some embodiments of this specification. In the example shown in FIG. 6, a model depth of the graph neural network is k=2.

In the first iteration process (k=1), the source graph node is graph node u, and the target graph nodes are graph nodes P0, P1, P2, and P3. Accordingly, a node propagation representation of graph node u is separately propagated to graph nodes P0, P1, P2 and P3. Here, the node propagation feature of graph node u is equivalent to original feature information Xᵤ of graph node u. In an example, original feature information Xᵤ of each graph node can be obtained by performing embedding processing on node attribute information of the graph node. By using the processing above, the original feature information of each graph node can be represented as a vector of a specified dimension, and a value of each dimension is a real-number value between [0,1]. For example, when a specified dimension is 10-dimension, the original feature information Xᵤ of graph node u can be represented as, for example, a 10-dimensional vector [0.12,0.43,0.35,0.33,0.28,0.59,0.77,0.94,0.66,0.84].

At graph nodes P0, P1, P2, and P3, ATT_OP described above can be used to aggregate node propagation representations received by graph nodes P0, P1, P2, and P3 from neighboring graph node u, so as to obtain neighboring-node propagation representations z_{u,p0}¹, z_{u,p1}¹, z_{u,p2}¹, and z_{u,p3}¹ of graph nodes P0, P1, P2, and P3.

Then, at graph nodes P0, P1, P2, and P3, the LSTM aggregator is used to perform LSTM_OP on the neighboring-node propagation representations z_{u,p0}¹, z_{u,p1}¹, z_{u,p2}¹, and z_{u,p3}¹ of graph nodes P0, P1, P2, and P3 and node propagation representations h_{u,p0}⁰, h_{u,p1}⁰, h_{u,p2}⁰, and h_{u,p3}⁰ of the previous iteration process of the graph nodes to generate node propagation representations h_{u,p0}¹, h_{u,p1}¹, h_{u,p2}¹, and h_{u,p3}¹ of the first iteration process of graph nodes P0, P1, P2, and P3. In the first iteration process, values of h_{u,p0}⁰, h_{u,p1}⁰, h_{u,p2}⁰, and h_{u,p3}⁰ are 0.

In the second iteration process (k=2), source graph nodes are graph nodes P0, P1, P2, and P3, and target graph nodes are graph nodes P4, P5, and P6. Accordingly, a node propagation representation h_{u,p2}¹ of graph node P2 is propagated to graph nodes P4 and P5, and a node propagation representation h_{u,p3}¹ of graph node P3 is propagated to graph nodes P5 and P6. Because graph nodes P0 and P1 have no neighboring graph node, graph nodes P0 and P1 do not perform further node propagation processing.

At graph nodes P4 and P5, ATT_OP described above is used to aggregate node propagation representations received by graph nodes P4 and P5 from neighboring graph nodes, so as to obtain neighboring-node propagation representations z_{u,p4}² and z_{u,p4}² of graph nodes P4 and P5. Specifically, at graph node P4, ATT_OP described above is used to aggregate a node propagation representation h_{u,p2}¹ of graph node P2, so as to obtain a neighboring-node propagation representation z_{u,p4}² of graph node P4. At graph node P5, ATT_OP described above is used to aggregate node propagation representations h_{u,p2}¹ and h_{u,p3}¹ of graph nodes P2 and P3, so as to obtain a neighboring-node propagation representation z_{u,p5}² of graph node P5. At graph node P6, ATT_OP described above is used to aggregate a node propagation representation h_{u,p3}¹ of graph node P3, so as to obtain a neighboring-node propagation representation z_{u,p6}² of graph node P6.

Then, at graph nodes P4, P5, and P6, the LSTM aggregator is used to perform LSTM_OP on the neighboring-node propagation representations z_{u,p4}², z_{u,p5}², and z_{u,p6}² of graph nodes P4, P5, and P6 and node propagation representations h_{u,p4}¹, h_{u,p5}¹, and h_{u,p6}¹ of the previous iteration process of the graph nodes to generate node propagation representations h_{u,p4}², h_{u,p5}², and h_{u,p6}² of the second iteration process of graph nodes P4, P5, and P6. In the example of FIG. 6, because node representation propagation processing of graph nodes P4, P5, and P6 is not involved in the first iteration process, values of h_{u,p4}¹, h_{u,p5}¹, and h_{u,p6}¹ are 0.

After the above-mentioned iteration processing is performed to obtain the node propagation representations of the graph nodes, the node representation aggregation is performed. Similarly, a specified quantity of iteration processes need to be performed for the node representation aggregation.

In each iteration process of the node representation aggregation, a node representation of the current iteration process of the second graph node is generated based on a node representation of the previous iteration process of the second graph node and a node representation of the previous iteration process of a neighboring graph node of the second graph node. Here, an initial node representation of a graph node involved in the node representation aggregation is generated based on a node propagation representation of the graph node and an original feature of the graph node.

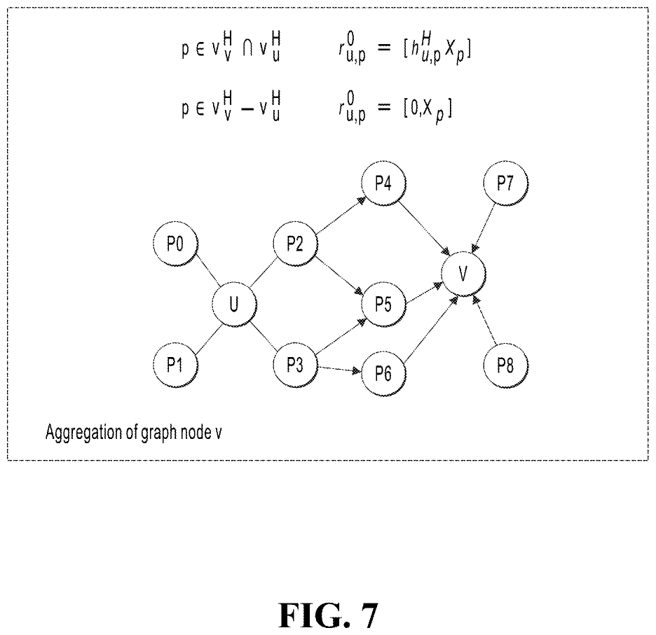

FIG. 7 is an example schematic diagram illustrating a node representation aggregation process, according to some embodiments of this specification. The example of FIG. 7 shows node representation aggregation performed on graph node v.

All graph nodes (for example, graph nodes P2 to P8 in FIG. 1 in case of H=2) belonging to νᵥ^{H} are divided into two types of different graph nodes. One type of graph nodes fall within p∈νᵥ^{H}∩νᵤ^{H} (an intersection set), and the other type of graph nodes fall within p∈νᵥ^{H}−νᵤ^{H} (a difference set). Here, νᵥ^{H} represents an H-step neighbor centered at graph node v, and νᵤ^{H} represents an H-step neighbor centered at graph node u. When the node representation and aggregation is performed, an initial node representation r_{u,p}⁰ of each graph node p is first determined. In an example, the initial node representation of the graph node is generated by splicing a node propagation representation of the graph node and an original feature of the graph node. For example, the initial node representation r_{u,p}⁰ of graph node p can be represented by using the following equation:

$${r}_{u , p}^{0} = \{ \begin{matrix}[ {h}_{u , p}^{H} , {X}_{p} ] & p ∈ {v}_{v}^{H} ∩ {v}_{u}^{H} \\ [ 0 , {X}_{p} ] & p ∈ {v}_{v}^{H} - {v}_{u}^{H}\end{matrix} ∀ p ∈ {v}_{v}^{H}$$

After the initial node representation of each graph node is obtained as described above, a node representation of graph node p in each iteration process is determined based on the iteration process. In an example, for the kth iteration process, r_{u,p}^{k} of graph node p can be determined as follows by using an aggregation function AGG(⋅) in the graph neural network:

r_{u,p}^{k}←AGG(r_{u,p}^{k-1},{r_{u,i}^{k-1}|(i,p)∈εᵥ^{H}}),∀p∈νᵥ^{H}

AGG(⋅) is the aggregation function in the graph neural network, r_{u,p}^{k} is a node representation of graph node p in the kth iteration process, r_{u,p}^{k-1} is a node representation of graph node p in the (k−1)th iteration process, εᵥ^{H} represents an edge between H-step neighboring nodes centered at graph node v, (i,p) represents an edge from graph node i to graph node p, and r_{u,i}^{k-1} is a node representation of graph node i in the (k−1)th iteration process.

The node representation aggregation is performed iteratively in the way described above to finally obtain an H-order node representation (H iterations) r_{u,v}^{H} of graph node v, and the H-order node representation is used as a final node representation of graph node v.

Referring back to FIG. 2, at 220, node representation propagation and node representation aggregation are performed starting from the second graph node to determine a node representation of the first graph node. A processing process of step 220 is similar to the processing process of step 210, except that the node representation propagation and the node representation aggregation start from graph node v and a node representation of graph node u is finally computed. Details are omitted here for simplicity. Therefore, an H-order node representation (H iterations) r_{v,u}^{H} of graph node u is obtained, and is used as a final node representation of graph node u. It is worthwhile to note that, in this specification, the first graph node or the second graph node can be referred to as an aggregation graph node.

At 230, a node relationship representation between the first graph node and the second graph node is generated based the node representations of the first graph node and the second graph node. In an example, the node representations of the first graph node and the second graph node can be spliced to generate the node relationship representation between the first graph node and the second graph node. For example, for graph nodes u and v, the node representation r_{v,u}^{H} of graph node u and the node representation r_{u,v}^{H} of graph node v can be spliced to obtain a node relationship representation s_{u,v}=[r_{u,v}^{H},r_{v,u}^{H}] of graph node u and graph node v.

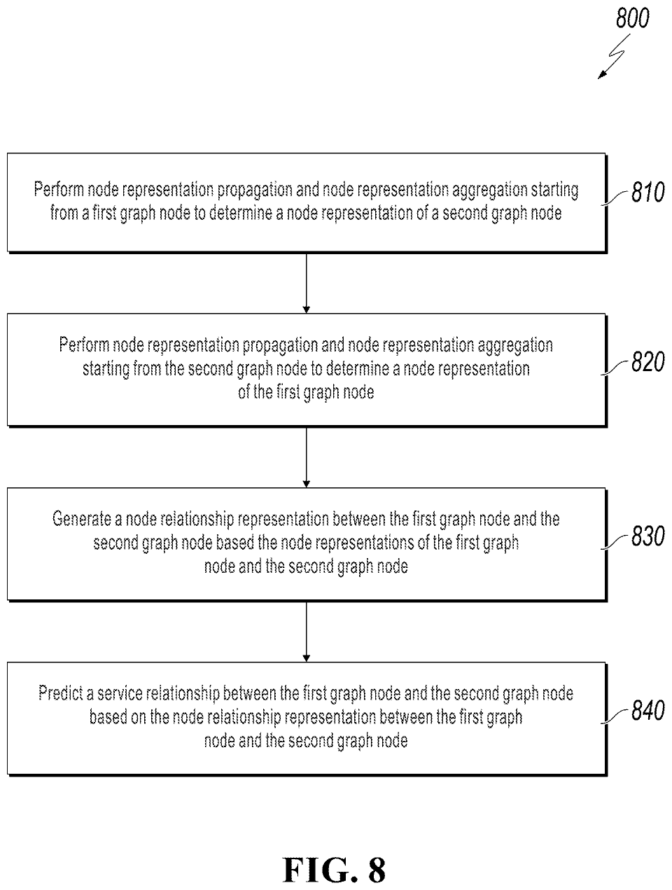

FIG. 8 is an example flowchart illustrating a graph node service relationship prediction method 800 for predicting a service relationship between a first graph node and a second graph node in graph data, according to some embodiments of this specification. In the example of FIG. 8, operations 810 to 830 are exactly the same as the operations 210 to 230 above. Details are omitted here for simplicity.

After the node relationship representation between the first graph node and the second graph node is obtained as described above, at 840, graph node service relationship prediction is performed based on the node relationship representation between the first graph node and the second graph node. A graph node service relationship prediction process based on a node relationship representation can be implemented by using any prediction method applicable to the art.

For example, the graph node service relationship prediction process based on a node relationship representation can be implemented by using, for example, a machine learning model of a graph neural network. In an example, during training of a machine learning model, the following function can be used as loss function for model training.

$$Loss = - \frac{1}{\vert ℒ \vert} {\sum }_{( < u , v > , y ) εℒ} y log ( \hat{y} ) + ( 1 - y ) log ( 1 - \hat{y} )$$

ŷ is a model prediction result, y=MLP(s_{u,v}), MLP(⋅) is a multi-layer perceptron, and y∈{0,1}. When a service relationship exists between <u,v>, y=1, or otherwise y=0. [symbol] ={(<u,v>,y)} is a training sample data set. | [symbol] | represents a size of the training sample data set, that is, a quantity of pieces of training sample data.

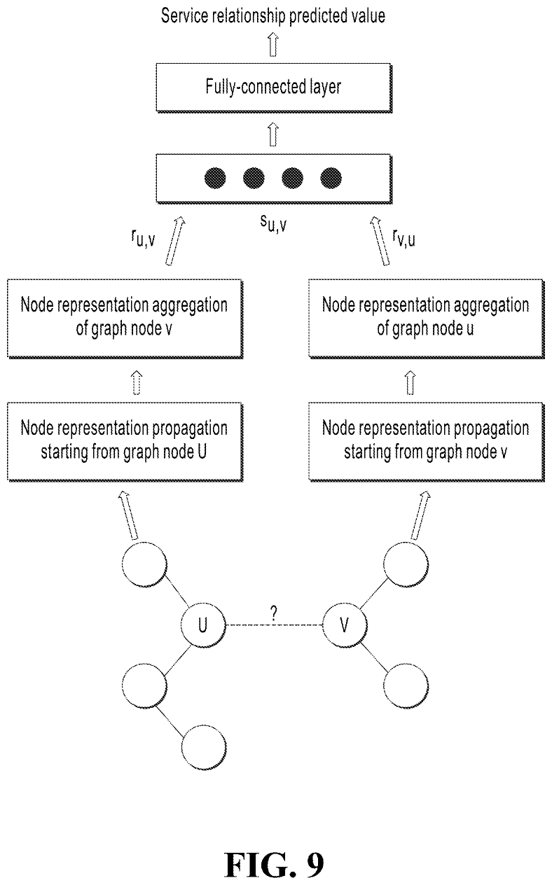

FIG. 9 is an example schematic diagram illustrating a node service relationship prediction process based on a graph neural network, according to some embodiments of this specification. The example of FIG. 9 shows a process of predicting a node service relationship between graph node u and graph node v.

As shown in FIG. 9, first, starting from graph node u, node representation propagation and node representation aggregation corresponding to specified quantities of iterations are first performed to determine a node representation r_{u,v}^{H} of graph node v; and starting from graph node v, node representation propagation and node representation aggregation corresponding to specified quantities of iterations are performed to determine a node representation r_{v,u}^{H} of graph node u. Then, the node representation r_{u,v}^{H} of graph node v and the node representation r_{v,u}^{H} of graph node u are spliced to obtain a node relationship representation s_{u,v} of graph node u and graph node v. Here, the node representations r_{v,u}^{H} and r_{u,v}^{H} of graph nodes u and v and the node relationship representation s_{u,v} between graph node u and graph node v can be represented as representation vectors. The representation vector can include multiple dimensions, and a dimension value of each dimension can be represented by using a positive real number, for example, can be represented by using a value between [0, 1]. The node relationship representation s_{u,v} is provided to a fully connected layer (FC layer) of the graph neural network for service relationship prediction. Then, whether a service relationship exists between graph nodes is predicted based on a service relationship prediction value. For example, the obtained service relationship prediction value can be a probability value. When the obtained service relationship prediction value is not less than a predetermined threshold, it is considered that a service relationship exists between the graph nodes. When the obtained service relationship prediction value is less than a predetermined threshold, it is considered that no service relationship exists between graph nodes.

The node representation propagation and the node representation aggregation are performed in a node representation determining process by using the inter-node service relationship prediction. The graph node representation obtained in this way is incorporated into graph node attribute information and interaction structure information of the two graph nodes, so that the obtained graph node relationship representation between the graph nodes can accurately reflect the node attribute information of the graph nodes and the interaction structure information between the graph nodes, thereby improving accuracy of predicting a service relationship between the graph nodes.

In addition, by using the inter-node service relationship prediction and by further propagating edge relationship feature data between the two graph nodes during node representation propagation, the obtained graph node relationship representation between the graph nodes can further reflect the edge feature information between the graph nodes, thereby further improving accuracy of predicting a service relationship between the graph nodes.

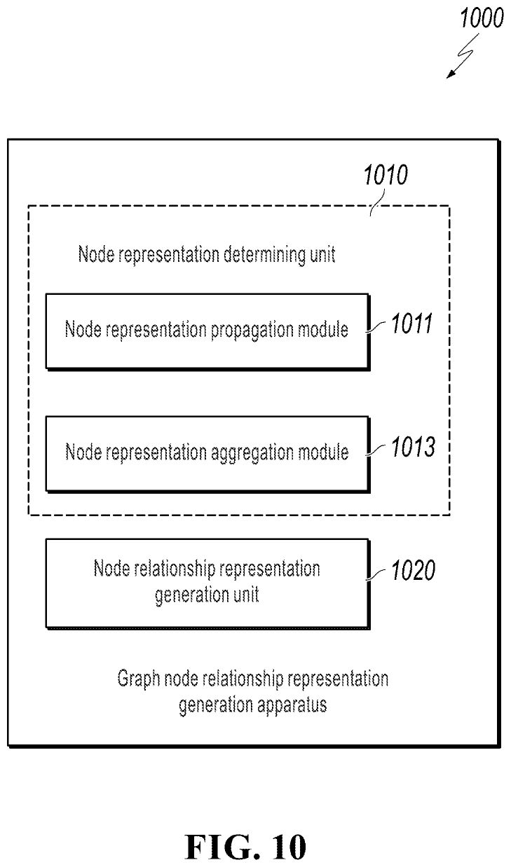

FIG. 10 is an example block diagram illustrating a graph node relationship representation generation apparatus 1000 for generating a node relationship representation between a first graph node and a second graph node in graph data, according to some embodiments of this specification. As shown in FIG. 10, the graph node relationship representation generation apparatus 1000 includes a node representation determining unit 1010 and a node relationship representation generation unit 1020.

The node representation determining unit 1010 is configured to separately perform node representation propagation and node representation aggregation starting from the first graph node and the second graph node to determine node representations of the second graph node and the first graph node. For the operations of the node representation determining unit 1010, refer to the operations described above with reference to 210 and 220 in FIG. 2.

The node relationship representation generation unit 1020 is configured to generate a node relationship representation between the first graph node and the second graph node based on the node representations of the first graph node and the second graph node. For the operations of the node relationship representation generation unit 1020, refer to the operations described above with reference to 230 in FIG. 2.

The node representation determining unit 1010 includes a node representation propagation module 1011 and a node representation aggregation module 1013. The node representation propagation module 1011 and the node representation aggregation module 1013 are configured to perform specified quantities of iteration processes to separately determine the node representations of the first graph node and the second graph node.

Specifically, in each iteration process, the node representation propagation module 1011 is configured to propagate a node propagation representation of the previous iteration process of each source graph node in a source graph node set of a current iteration process to each target graph node in a target graph node set of the source graph node, where the target graph node set includes neighboring graph nodes of the source graph node; and generate node propagation representations of the current iteration process of the target graph nodes based on node propagation representations received by the target graph nodes and node propagation representations of the target graph nodes of the previous iteration process.

In each iteration process, the node representation aggregation module 1013 is configured to generate a node representation of a current iteration process of an aggregation graph node based on a node representation of the previous iteration process of the aggregation graph node and a node representation of the previous iteration process of a neighboring graph node of the aggregation graph node, where the aggregation graph node includes the first graph node or the second graph node, and an initial node representation of a graph node is generated based on a node propagation representation of the graph node and an original feature of the graph node. It is worthwhile to note that the node representation aggregation module 1013 performs the iteration processes after the node representation propagation module 1011 completes the iteration processes.

In addition, in some embodiments, the node relationship representation generation unit 1020 splices the node representations of the first graph node and the second graph node to generate the node relationship representation between the first graph node and the second graph node.

In addition, in some embodiments, when an edge relationship feature exists between graph nodes, the node representation propagation module 1011 is configured to generate the node propagation representations of the current iteration process of the target graph nodes based on node propagation representations received by the target graph nodes from neighboring graph nodes, edge relationship features between the target graph nodes and the neighboring graph nodes, and the node propagation representations of the target graph nodes of the previous iteration process.

In addition, in some embodiments, the node representation aggregation module 1013 generates the initial node representation of the graph node by splicing the node propagation representation of the graph node and the original feature of the graph node.

In addition, in some embodiments, when the graph node relationship representation generation apparatus 1000 is implemented based on a graph neural network, the node representation aggregation module 1013 is configured to generate the node representation of the current iteration process of the aggregation graph node by aggregating the node representation of the previous iteration process of the aggregation graph node and the node representation of the previous iteration process of the neighboring graph node of the aggregation graph node by using an aggregation function.

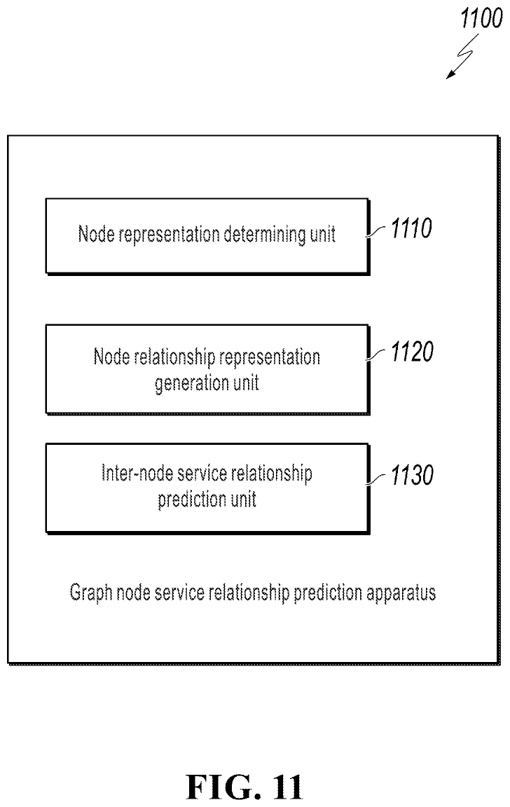

FIG. 11 is an example flowchart illustrating a graph node service relationship prediction apparatus 1100 for predicting a service relationship between a first graph node and a second graph node in graph data, according to some embodiments of this specification. As shown in FIG. 11, the graph node service relationship prediction apparatus 1100 includes a node representation determining unit 1110, a node relationship representation generation unit 1120, and an inter-node service relationship prediction unit 1130. The operations and structures of the node representation determining unit 1110 and the node relationship representation generation unit 1120 are the same as the operations and structures of the node representation determining unit 1010 and the node relationship representation generation unit 1020. Details are omitted here for simplicity.

The inter-node service relationship prediction unit 1130 is configured to predict a service relationship between the first graph node and the second graph node based on the node relationship representation between the first graph node and the second graph node. For the operations of the inter-node service relationship prediction unit 1130, refer to the operations described above with reference to 840 in FIG. 8.

The graph node relationship representation generation methods, the graph node relationship representation generation apparatuses, the graph node service relationship prediction methods, and the graph node service relationship prediction apparatuses according to some embodiments of this specification are described above with reference to FIG. 1 to FIG. 11. The above-mentioned graph node relationship representation generation apparatuses and graph node service relationship prediction apparatuses can be implemented by hardware, software or a combination of hardware and software.

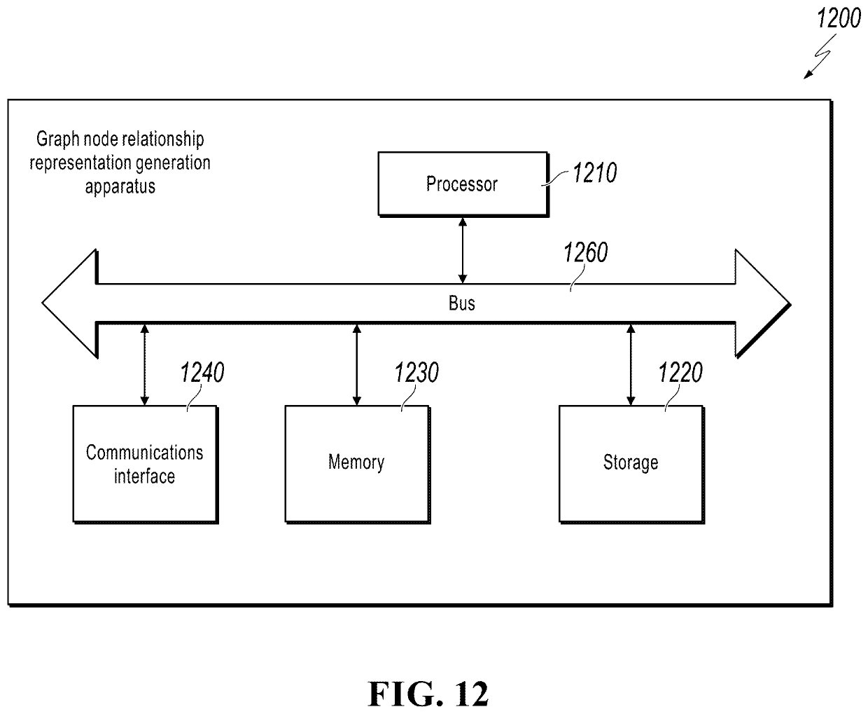

FIG. 12 is a schematic diagram illustrating a graph node relationship representation generation apparatus 1200 that is implemented based on a computer system and that is used to generate a node relationship representation between a first graph node and a second graph node in graph data, according to some embodiments of this specification. As shown in FIG. 12, the graph node relationship representation generation apparatus 1200 can include at least one processor 1210, a storage (for example, a non-volatile storage) 1220, a memory 1230, and a communications interface 1240, and the at least one processor 1210, the storage 1220, the memory 1230, and the communications interface 1240 are connected together by using a bus 1260. The at least one processor 1210 executes at least one computer-readable instruction (namely, the above-mentioned elements implemented in a software form) stored or encoded in the storage.

In some embodiments, the storage stores a computer-executable instruction, and when executed, the computer-executable instruction enables the at least one processor 1210 to separately perform node representation propagation and node representation aggregation starting from the first graph node and the second graph node to determine node representations of the second graph node and the first graph node; and generate a node relationship representation between the first graph node and the second graph node based on the node representations of the first graph node and the second graph node; where specified quantities of iteration processes are performed for the node representation propagation and the node representation aggregation; during the node representation propagation: a node propagation representation of the previous iteration process of each source graph node in a source graph node set of a current iteration process is propagated to each target graph node in a target graph node set of the source graph node, where the target graph node set includes neighboring graph nodes of the source graph node; and node propagation representations of the current iteration process of the target graph nodes are generated based on node propagation representations received by the target graph nodes and node propagation representations of the target graph nodes of the previous iteration process; and during the node representation aggregation: a node representation of a current iteration process of an aggregation graph node is generated based on a node representation of the previous iteration process of the aggregation graph node and a node representation of the previous iteration process of a neighboring graph node of the aggregation graph node, where the aggregation graph node includes the first graph node or the second graph node, and an initial node representation of a graph node is generated based on a node propagation representation of the graph node and an original feature of the graph node.

It should be understood that, when executed, the computer-executable instruction stored in the storage enables the at least one processor 1210 to perform the above-mentioned operations and functions described with reference to FIG. 1 to FIG. 7 and FIG. 10 in the embodiments of this specification.

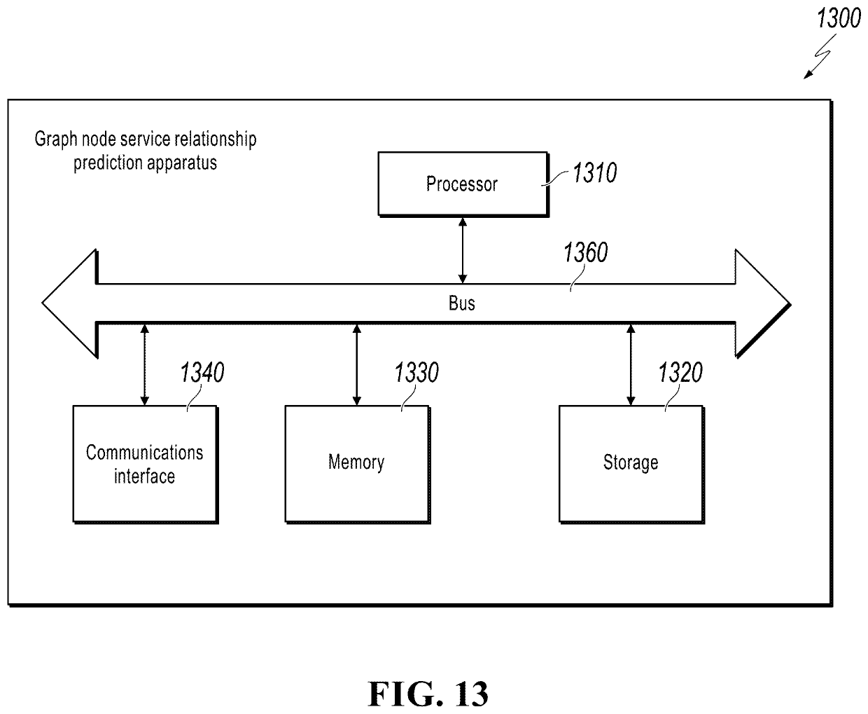

FIG. 13 is a schematic diagram illustrating a graph node service relationship prediction apparatus 1300 that is implemented based on a computer system and that is used to predict a service relationship between a first graph node and a second graph node in graph data, according to some embodiments of this specification. As shown in FIG. 13, the graph node service relationship prediction apparatus 1300 can include at least one processor 1310, a storage (for example, a non-volatile storage) 1320, a memory 1330, and a communications interface 1340, and the at least one processor 1310, the storage 1320, the memory 1330, and the communications interface 1340 are connected together by using a bus 1360. The at least one processor 1310 executes at least one computer-readable instruction (namely, the above-mentioned elements implemented in a software form) stored or encoded in the storage.

In some embodiments, the storage stores a computer-executable instruction, and when executed, the computer-executable instruction enables the at least one processor 1310 to separately perform node representation propagation and node representation aggregation starting from the first graph node and the second graph node to determine node representations of the second graph node and the first graph node; generate a node relationship representation between the first graph node and the second graph node based on the node representations of the first graph node and the second graph node; and predict a service relationship between the first graph node and the second graph node based on the node relationship representation between the first graph node and the second graph node, where specified quantities of iteration processes are performed for the node representation propagation and the node representation aggregation; during the node representation propagation: a node propagation representation of the previous iteration process of each source graph node in a source graph node set of a current iteration process is propagated to each target graph node in a target graph node set of the source graph node, where the target graph node set includes neighboring graph nodes of the source graph node; and node propagation representations of the current iteration process of the target graph nodes are generated based on node propagation representations received by the target graph nodes and node propagation representations of the target graph nodes of the previous iteration process; and during the node representation aggregation: a node representation of a current iteration process of an aggregation graph node is generated based on a node representation of the previous iteration process of the aggregation graph node and a node representation of the previous iteration process of a neighboring graph node of the aggregation graph node, where the aggregation graph node includes the first graph node or the second graph node, and an initial node representation of a graph node is generated based on a node propagation representation of the graph node and an original feature of the graph node.

It should be understood that, when executed, the computer-executable instruction stored in the storage enables the at least one processor 1310 to perform the above-mentioned operations and functions described with reference to FIG. 8, FIG. 9, and FIG. 11 in the embodiments of this specification.

According to some embodiments, a program product such as a machine-readable medium (for example, a non-transitory machine-readable medium) is provided. The machine-readable medium can have an instruction (to be specific, the above-mentioned element implemented in a software form). When executed by a machine, the instruction enables the machine to perform the above-mentioned operations and functions described with reference to FIG. 1 to FIG. 11 in the embodiments of this specification. Specifically, a system or an apparatus equipped with a readable storage medium can be provided, and software program code for implementing the functions in any of the above-mentioned embodiments is stored in the readable storage medium, so that a computer or a processor of the system or the apparatus reads and executes the instruction stored in the readable storage medium.

In such case, the program code read from the readable medium can implement the functions in any one of some embodiments described above, and therefore the machine-readable code and the readable storage medium storing the machine-readable code form a part of this specification.

Some embodiments of the readable storage medium include a floppy disk, a hard disk, a magneto-optical disk, an optical disc (such as a CD-ROM, a CD-R, a CD-RW, a DVD-ROM, a DVD-RAM, a DVD-RW, and a DVD-RW), a magnetic tape, a non-volatile memory card, and a ROM. Alternatively, the program code can be downloaded from a server computer or a cloud by a communication network.

According to some embodiments, a computer program product is provided, where the computer program product includes a computer program, and when the computer program is executed by a processor, the processor is enabled to perform the operations and functions described above with reference to FIG. 1 to FIG. 11 in some embodiments of this specification.

A person skilled in the art should understand that various variations and modifications can be made to some embodiments disclosed above without departing from the essence of this application. Therefore, the protection scope of this specification should be defined by the appended claims.

It is worthwhile to note that, not all the steps and units in the above-mentioned processes and system structure diagrams are needed, and some steps or units can be ignored based on an actual need. An order of performing the steps is not fixed, and can be determined based on a need. The apparatus structure described in some embodiments can be a physical structure or a logical structure. In other words, some units can be implemented by the same physical entity, or some units can be implemented by a plurality of physical entities, or can be implemented together by some components in a plurality of independent devices.

In some above-mentioned embodiments, a hardware unit or module can be implemented mechanically or electrically. For example, a hardware unit, a module, or a processor can include a permanent dedicated circuit or logic (such as a dedicated processor, FPGA, or ASIC) to complete a corresponding operation. The hardware unit or the processor can further include a programmable logic or circuit (such as a general-purpose processor or another programmable processor), and can be set temporarily by software to complete a corresponding operation. Some specific implementations (mechanical methods, dedicated permanent circuits, or temporarily disposed circuits) can be determined based on cost and time considerations.

The specific implementations illustrated above with reference to the accompanying drawings describe some example embodiments, but do not represent all embodiments that can be implemented or fall within the protection scope of the claims. The term “example” used throughout this specification means “used as an example, an instance, or an illustration”, but does not mean “preferred” or “advantageous” over other embodiments. Specific implementations include specific details for the purpose of providing an understanding of the described technologies. However, these technologies can be implemented without these specific details. In some instances, to avoid obscuring the described concepts in the embodiments, well-known structures and apparatuses are shown in the form of a block diagram.

The above-mentioned descriptions of this disclosure are provided to enable any person of ordinary skill in the art to implement or use this disclosure. Various modifications made to this specification are clear to a person of ordinary skill in the art, and the general principles defined in this specification can also be applied to other variants without departing from the protection scope of this specification. Therefore, this disclosure is not limited to the examples and designs described in this specification, but corresponds to the widest scope of principles and novel features disclosed in this specification.

1. A computer-implemented method comprising:
determining node representations of a first graph node and a second graph node based on performing node representation propagation and node representation aggregation starting from the first graph node and the second graph node; and
generating a node relationship representation between the first graph node and the second graph node in graph data based on the node representations; wherein
the node representation aggregation comprising a plurality of iterations, a node propagation representation of a previous iteration of each source graph node in a source graph node set of a current iteration is propagated to each target graph node in a target graph node set of the source graph node, and the target graph node set comprises neighboring graph nodes of the source graph node; wherein
node propagation representations of the current iteration of target graph nodes are generated based on node propagation representations received by the target graph nodes and node propagation representations of the target graph nodes of the previous iteration; and wherein
a node representation of a current iteration of an aggregation graph node is generated based on a node representation of the previous iteration of the aggregation graph node and a node representation of the previous iteration of a neighboring graph node of the aggregation graph node, the aggregation graph node comprises the first graph node or the second graph node, and an initial node representation of a graph node is generated based on a node propagation representation of the graph node and an original feature of the graph node.

2. The computer-implemented method according to claim 1, wherein generating the node relationship representation between the first graph node and the second graph node comprises:
splicing the node representations of the first graph node and the second graph node to generate the node relationship representation between the first graph node and the second graph node.

3. The computer-implemented method according to claim 1, wherein the node propagation representations of the current iteration of the target graph nodes are generated based on node propagation representations received from neighboring graph nodes, edge relationship features between the target graph nodes and the neighboring graph nodes, and the node propagation representations of the target graph nodes of the previous iteration.

4. The computer-implemented method according to claim 1, wherein the initial node representation of a graph node is generated based on splicing the node propagation representation of the graph node and the original feature of the graph node.

5. The computer-implemented method according to claim 1, wherein the computer-implemented method is implemented based on a graph neural network.

6. The computer-implemented method according to claim 5, wherein the node representation of the current iteration of the aggregation graph node is generated based on aggregating the node representation of the previous iteration of the aggregation graph node and the node representation of the previous iteration of the neighboring graph node of the aggregation graph node by using an aggregation function.

7. The computer-implemented method according to claim 6, wherein the graph neural network comprises a graph neural network having an Attention mechanism and a long-short term memory (LSTM) aggregator.

8. The computer-implemented method according to claim 7, wherein the node propagation representations of the current iteration of the target graph nodes are generated based on:
aggregating, by using an Attention operation, the node propagation representations received by the target graph nodes to obtain neighboring-node propagation representations of the target graph nodes; and
performing, by using the LSTM aggregator, LSTM aggregation on the neighboring-node propagation representations of the target graph nodes and the node propagation representations of the previous iteration of the target graph nodes to generate the node propagation representations of the current iteration of the target graph nodes.

9. The computer-implemented method according to claim 1, wherein the graph data is generated based on service data, and wherein the service data comprisees one of:
social data;
financial transaction data;
product transaction data; and
enterprise supply relationship data.

10. A non-transitory, computer-readable medium storing one or more instructions executable by a computer system to perform operations comprising:
determining node representations of a first graph node and a second graph node based on performing node representation propagation and node representation aggregation starting from the first graph node and the second graph node; and
generating a node relationship representation between the first graph node and the second graph node in graph data based on the node representations; wherein
the node representation aggregation comprising a plurality of iterations, a node propagation representation of a previous iteration of each source graph node in a source graph node set of a current iteration is propagated to each target graph node in a target graph node set of the source graph node, and the target graph node set comprises neighboring graph nodes of the source graph node; wherein
node propagation representations of the current iteration of target graph nodes are generated based on node propagation representations received by the target graph nodes and node propagation representations of the target graph nodes of the previous iteration; and wherein
a node representation of a current iteration of an aggregation graph node is generated based on a node representation of the previous iteration of the aggregation graph node and a node representation of the previous iteration of a neighboring graph node of the aggregation graph node, the aggregation graph node comprises the first graph node or the second graph node, and an initial node representation of a graph node is generated based on a node propagation representation of the graph node and an original feature of the graph node.

11. The non-transitory, computer-readable medium according to claim 10, wherein generating the node relationship representation between the first graph node and the second graph node comprises:
splicing the node representations of the first graph node and the second graph node to generate the node relationship representation between the first graph node and the second graph node.

12. The non-transitory, computer-readable medium according to claim 10, wherein the node propagation representations of the current iteration of the target graph nodes are generated based on node propagation representations received from neighboring graph nodes, edge relationship features between the target graph nodes and the neighboring graph nodes, and the node propagation representations of the target graph nodes of the previous iteration.

13. The non-transitory, computer-readable medium according to claim 10, wherein the initial node representation of a graph node is generated based on splicing the node propagation representation of the graph node and the original feature of the graph node.

14. The non-transitory, computer-readable medium according to claim 10, wherein the operations are implemented based on a graph neural network.

15. The non-transitory, computer-readable medium according to claim 14, wherein the node representation of the current iteration of the aggregation graph node is generated based on aggregating the node representation of the previous iteration of the aggregation graph node and the node representation of the previous iteration of the neighboring graph node of the aggregation graph node by using an aggregation function.

16. The non-transitory, computer-readable medium according to claim 15, wherein the graph neural network comprises a graph neural network having an Attention mechanism and a long-short term memory (LSTM) aggregator.

17. The non-transitory, computer-readable medium according to claim 16, wherein the node propagation representations of the current iteration of the target graph nodes are generated based on:
aggregating, by using an Attention operation, the node propagation representations received by the target graph nodes to obtain neighboring-node propagation representations of the target graph nodes; and
performing, by using the LSTM aggregator, LSTM aggregation on the neighboring-node propagation representations of the target graph nodes and the node propagation representations of the previous iteration of the target graph nodes to generate the node propagation representations of the current iteration of the target graph nodes.

18. The non-transitory, computer-readable medium according to claim 10, wherein the graph data is generated based on service data, and wherein the service data comprisees one of:
social data;
financial transaction data;
product transaction data; and
enterprise supply relationship data.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
determining node representations of a first graph node and a second graph node based on performing node representation propagation and node representation aggregation starting from the first graph node and the second graph node; and
generating a node relationship representation between the first graph node and the second graph node in graph data based on the node representations; wherein
the node representation aggregation comprising a plurality of iterations, a node propagation representation of a previous iteration of each source graph node in a source graph node set of a current iteration is propagated to each target graph node in a target graph node set of the source graph node, and the target graph node set comprises neighboring graph nodes of the source graph node; wherein
node propagation representations of the current iteration of the target graph nodes are generated based on node propagation representations received by the target graph nodes and node propagation representations of the target graph nodes of the previous iteration; and
wherein
a node representation of a current iteration of an aggregation graph node is generated based on a node representation of the previous iteration of the aggregation graph node and a node representation of the previous iteration of a neighboring graph node of the aggregation graph node, the aggregation graph node comprises the first graph node or the second graph node, and an initial node representation of a graph node is generated based on a node propagation representation of the graph node and an original feature of the graph node.

20. The computer-implemented system according to claim 19, wherein generating the node relationship representation between the first graph node and the second graph node comprises:
splicing the node representations of the first graph node and the second graph node to generate the node relationship representation between the first graph node and the second graph node.
